(19) United States
(12) Patent Application Publication
(10) Pub. No.: US 2017/0266514 A1
(43) Pub. Date: Sep. 21, 2017

(54) GOLF BALL LINER

(71) Applicant: Min Gyu OH, Daegu (KR)

(72) Inventor: Min Gyu OH, Daegu (KR)

(21) Appl. No.: 15/381,784

(22) Filed: Dec. 16, 2016

(30) Foreign Application Priority Data
Mar. 21, 2016 (KR) 10-2016-0033168

(51) Int. Cl. A63B 45/02; B41K 1/00; A63B 37/00

(52) U.S. Cl. CPC A63B 45/02; A63B 37/0022; B41K 1/00

(57) ABSTRACT

Provided is a golf ball liner for rapidly and exactly printing, on a golf ball, a putting line or a mark indicating the owner of the ball. The golf ball liner includes a housing having an inside space in which a golf ball is accommodated, a moving part mounted on the housing and configured to move toward or away from the golf ball, a supporter mounted in an inside space of the moving part, a stamp supported by the supporter and configured to move with the moving part and the supporter to print a putting line or mark on the golf ball, and a first detachable part formed on each of the stamp and the supporter and configured to couple or separate the stamp to or from the supporter.

### CROSS-REFERENCE TO RELATED APPLICATION

This application claims priority to and the benefit of Korean Patent Application No. 10-2016-0033168, filed on Mar. 21, 2016, the disclosure of which is incorporated herein by reference in its entirety.

### BACKGROUND

### 1. Field of the Invention

The present invention relates to a golf ball liner configured to rapidly and exactly print a mark for easily distinguishing the owner of a ball among balls used by a plurality of persons in a round of golf and a putting line for informing the owner of a putting direction.

### 2. Discussion of Related Art

Since golf is becoming popular, the number of persons coming to golf courses is increasing day by day, but, because the supply of golf courses is insufficient for the number of persons, recently, each round of golf is played with a very tight schedule at most of golf courses.

Accordingly, the number of persons in a round of golf has to be maximized, and, while playing a round of golf with the plurality of persons, a case frequently occurs in which closely located golf balls cannot be distinguished as to who owns which ball, and particularly, when balls are on golf green, the above case occurs more frequently, leading to large and small arguments.

Accordingly, in order to prevent such arguments, sometimes golfers individually make a specific mark or a mark using a name, initials, or the like on his or her golf ball using a felt pen or marker pen.

However, it is not easy to manually make an exact mark on a small golf ball having a curved surface, and when an excessively large mark is made, the excessively large mark makes an aesthetically undesirable effect and also greatly influences the round of golf.

(Patent Documentation 0001) Registered Utility Patent Publication No. 20-0320182 (Jul. 7, 2003).

### SUMMARY OF THE INVENTION

The present invention is directed to a golf ball liner capable of rapidly and exactly printing, on a golf ball, a putting line or a mark indicating the owner of the ball.

According to an aspect of the present invention, there is provided a golf ball liner including a housing having an inside space in which a golf ball is accommodated, a moving part mounted on the housing and configured to move toward or away from the golf ball, a supporter mounted in an inside space of the moving part, a stamp supported by the supporter and configured to move with the moving part and the supporter to print a putting line or mark on the golf ball, and a first detachable part formed on each of the stamp and the supporter and configured to couple or separate the stamp to or from the supporter.

The first detachable part may have first slides formed on both sides of one of the stamp and the supporter and first rails formed in both sides of the remainder so that the stamp is separated from or coupled to the supporter in a sliding manner

The golf ball liner may further include a second detachable part formed on each of the moving part and the supporter and configured to couple or separate the moving part to or from the supporter, wherein the second detachable part may have second slides formed on both sides of one of the moving part and the supporter and second rails formed in both sides of the remainder so that the stamp is separated from or coupled to the supporter in a sliding manner.

The golf ball liner may further include a return part installed between the moving part and the housing and configured to return the moving part moved in a direction of the golf ball to an original position thereof using an elastic force.

The golf ball liner may further include holders formed on both sides of the supporter and spaced a predetermined gap from the second rail or the second slide, guides formed on both sides of the housing and configured to guide the holders to stoppers, and the stoppers, each connected to an end of the guide in a perpendicular direction, wherein the holders are fixedly hooked on the stoppers when the moving part is rotated.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an exploded perspective view illustrating a golf ball liner according to an embodiment of the present invention;

FIG. 2 is a bottom view illustrating an internal state of a moving part applied to the golf ball liner according to the embodiment of the present invention;

FIG. 3 is a perspective view illustrating a supporter applied to the golf ball liner according to the embodiment of the present invention;

FIG. 4 is an exploded perspective view illustrating a stamp applied to the golf ball liner according to the embodiment of the present invention;

FIG. 5 is a cross-sectional view illustrating a coupled state of the golf ball liner according to the embodiment of the present invention;

FIG. 6 is a cross-sectional view illustrating an operation of the golf ball liner shown in FIG. 5;

FIG. 7 is a perspective view illustrating a process of replacing a putting-line printing stamp with a mark printing stamp, wherein the putting-line printing stamp and the mark printing stamp are applied to the golf ball liner according to the embodiment of the present invention;

FIG. 8 is a perspective view illustrating a shortened length of the golf ball liner according to the embodiment of the present invention; and

FIG. 9 is a cross-sectional view illustrating the golf ball liner shown in FIG. 8.

### DETAILED DESCRIPTION OF EXEMPLARY EMBODIMENTS

Exemplary embodiments of the present invention will be described in detail below with reference to the accompanying drawings.

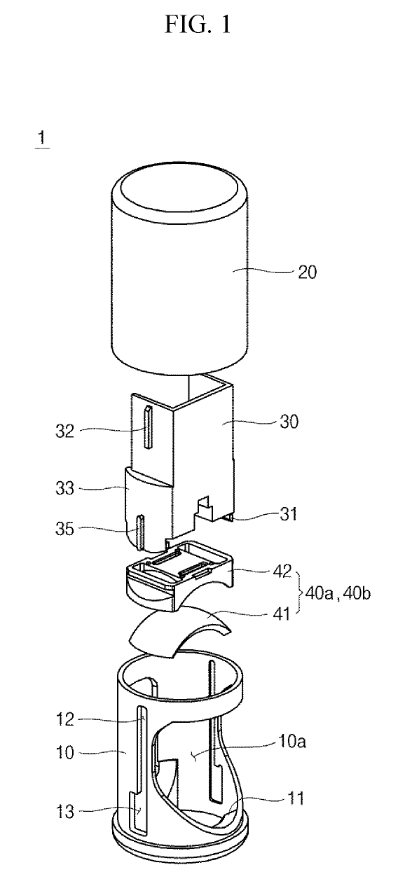

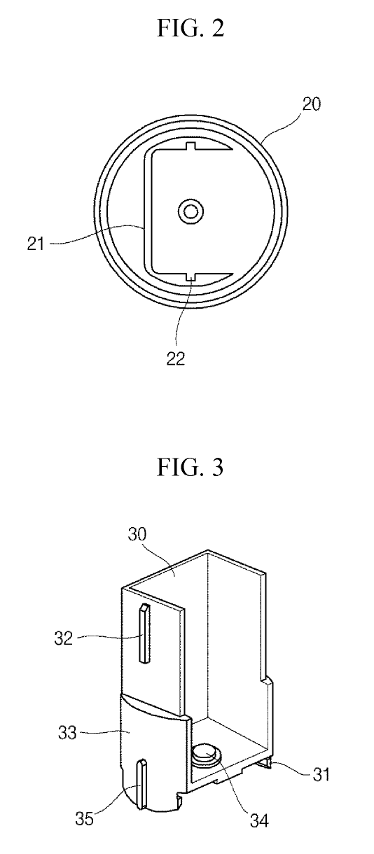

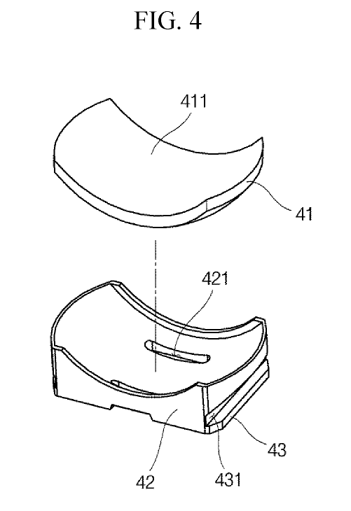

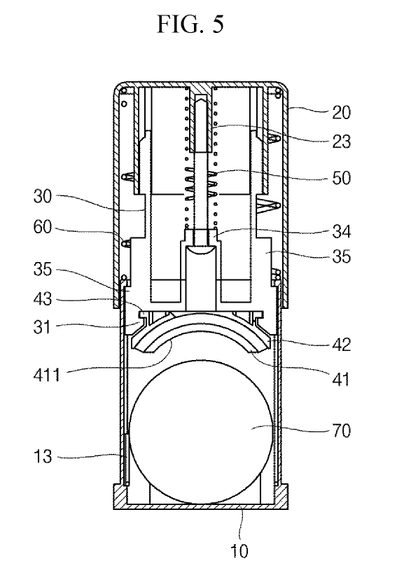

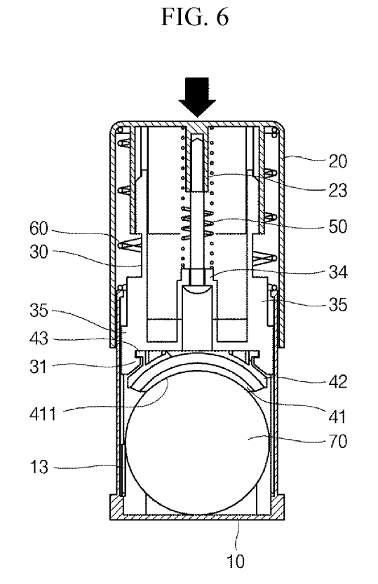

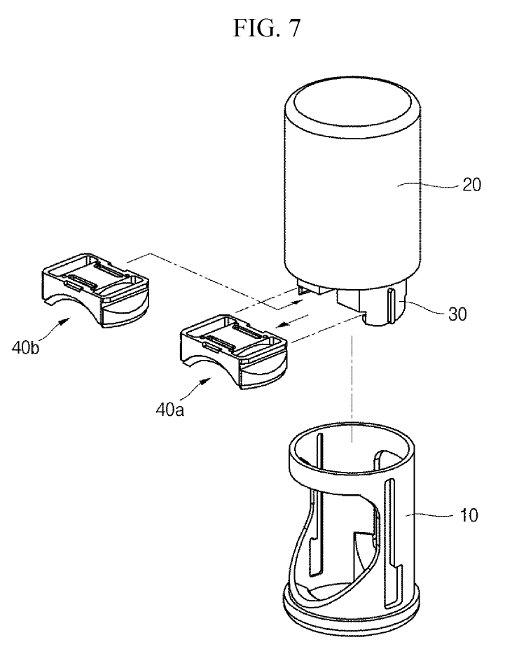

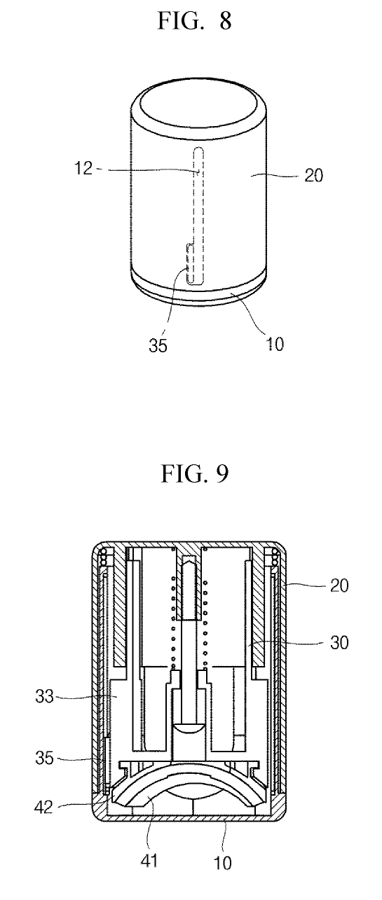

FIG. 1 is an exploded perspective view illustrating a golf ball liner according to an embodiment of the present invention, FIG. 2 is a bottom view illustrating an internal state of a moving part applied to the golf ball liner according to the embodiment of the present invention, FIG. 3 is a perspective view illustrating a supporter applied to the golf ball liner according to the embodiment of the present invention, FIG. 4 is an exploded perspective view illustrating a stamp applied to the golf ball liner according to the embodiment of the present invention, FIG. 5 is a cross-sectional view illustrating a coupled state of the golf ball liner according to the embodiment of the present invention, FIG. 6 is a cross-sectional view illustrating an operation of the golf ball liner shown in FIG. 5, FIG. 7 is a perspective view illustrating a process of replacing a putting-line printing stamp with a mark printing stamp, wherein the putting-line printing stamp and the mark printing stamp are applied to the golf ball liner according to the embodiment of the present invention, FIG. 8 is a perspective view illustrating a shortened length of the golf ball liner according to the embodiment of the present invention, and FIG. 9 is a cross-sectional view illustrating the golf ball liner shown in FIG. 8.

A golf ball liner 1 according to the embodiment of the present invention is for selectively printing a putting line or mark on a surface of a golf ball 70 and includes a housing 10, a moving part 20, a supporter 30, a stamp 40, a first detachable part.

The housing 10 in which the golf ball 70 is accommodated has an entrance 10a formed at a side thereof, through which the golf ball 70 enters or exits, and an empty space formed in the inside thereof and configured to accommodate the golf ball 70.

The housing 10 is illustrated as a cylindrical shape in the drawing, but the present invention is not limited thereto and may have various modified shapes other than the cylindrical shape as long as the golf ball 70 may be accommodated inside the structure thereof.

An upper portion of the housing 10 is open so that the stamp 40 and the supporter 30, which will be described below, may be accommodated in the empty space of the housing 10.

Further, holders 11 are formed on an edge of a bottom surface of the housing 10 to fix the golf ball 70 which passes through the entrance 10a and is accommodated in the empty space.

One side surface of the holder 11 is in contact with an inner wall of the housing 10, and the other side surface opposite the one side surface is recessed in a curved shape.

That is, the other side surface of the holder 11 is formed to have an inner circumferential surface corresponding to an outer circumferential surface of the golf ball 70 so as to fixedly surround a part of the golf ball 70, and therefore, the golf ball 70 is not moved by a contact impact occurring in a process of printing the putting line or mark on the surface of the golf ball 70 using the stamp 40 described below.

Meanwhile, guides 12 configured to guide the movement of holders 35 described below and stoppers 13 configured to restrict the movement of the holders 35 are formed on both sides of the housing 10.

The guide 12 is a hole formed in a longitudinal direction of the housing 10, and the stopper 13 is a hole connected and formed in a direction perpendicular to a lower end of the guide 12.

That is, a cross-sectional shape of a combination of the guide 12 and the stopper 13 is an “L” shape.

Here, the guides 12 are symmetrically formed with the inside space of the housing 10 interposed therebetween, and the stoppers 13 are formed in directions different from each other so that the holders 35 are fixed in a rotating manner.

A fixing method of the holders 35 through the stoppers 13 will be described in detail below.

The moving part 20 moves the stamp 40, which will be described below, toward or away from the golf ball 70 fixed to the holders 11. The moving part 20 is formed to have the same shape as the housing 10, an open lower portion, and an inside space and is mounted on an outer circumferential surface of the housing 10.

That is, an inner diameter of the moving part 20 is formed to be a diameter greater than an outer diameter of the housing 10 so that the moving part 20 moves in the longitudinal direction of the housing 10 and thus moves toward or away from the golf ball 70.

A first fixture 23 in a circular fin shape is formed integrally with a central portion of a ceiling surface of the moving part 20, and a frame 21 having a E-shaped cross-section is formed integrally with an edge of the ceiling surface.

The first fixture 23 is for fixing an auxiliary return part 50 described below, and the frame 21 is for forming second rails 22 or second slides 32, which will be described below, and for coupling the supporter 30 with the second rails 22 or second slides 32, and a fixing method of the auxiliary return part 50 and a coupling method of the supporter 30 will be described in detail below.

Further, a return part 60 formed with a coil spring is installed between an upper end of the housing 10 and the ceiling surface of the moving part 20, and thus, when the moving part 20 moves in a direction toward the housing 10, the moving part 20 is automatically returned to an original position due to an elastic force of the return part 60.

The supporter 30 is for supporting the stamp 40 described below, is formed in a box shape whose one side surface and upper surface are open and inside has an empty space, and is coupled to or separated from the moving part 20 in a sliding manner through a second detachable part including the second slides 32 and the second rails 22.

Specifically, the second slides 32 may be vertically formed on both sides of one of the moving part 20 and the supporter 30, the second rails 22 may be vertically formed in both sides of the remainder. Hereinafter, an example in which the second slides 32 are formed on the supporter 30 and the second rails 22 are formed in the moving part 20 of the frame 21 will be described.

The second slides 32 are symmetrically formed in a rectangular bar shape on both side surfaces of an upper side of the supporter 30, and the second rails 22 are symmetrically formed in a groove shape in inner surfaces of both sides of the frame 21, i.e., in a surface facing the first fixture 23.

Here, the second rail 22 is formed to have a length which is substantially the same as the second slide 32 so that the supporter 30 is coupled to or separated from the moving part 20 according to sliding guidance of the second slide 32.

Further, the second slide 32 is formed to have a width slightly greater than that of the second rail 22 to be coupled to the second rail 22 in a sliding manner by a forcible insertion method. Accordingly, as long as a predetermined amount of force is not applied to pull the supporter 30, the second slide 32 is not separated from the second rail 22, and thus coupling stability of the moving part 20 and the supporter 30 can be secured.

Meanwhile, a second fixture 34 in a circular fin shape is formed integrally with a central portion of a bottom surface of the supporter 30, wherein the second fixture 34 and the first fixture 23 fix an auxiliary return part 50.

The second fixture 34 is positioned on a vertical line on which the first fixture 23 is positioned, and the auxiliary return part 50 includes a coil spring.

The first fixture 23 is inserted into an upper side of the auxiliary return part 50 using a forcible insertion method, the second fixture 34 is inserted into a lower side of the auxiliary return part 50 using a forcible insertion method, and thus the auxiliary return part 50 is fixed between the moving part 20 and the supporter 30.

Meanwhile, bulging parts 33 are formed integrally with both side surfaces of the supporter 30, and the holder 35 moving along the guide 12 is formed integrally with the bulging part 33.

Here, the bulging part 33 is in contact with the supporter 30 from a central portion to a lower end of the supporter 30, has a part of a lower portion formed to have a length protruding downward from the supporter 30, and may thus form a first detachable part described below.

The holder 35 is formed in a rectangular bar shape having a predetermined length.

The holder 35 is formed on an outer surface of the lower portion of the bulging part 33, spaced a predetermined gap from the second slide 32, and inserted into the guide 12.

Here, since the supporter 30 is formed in the rectangular box shape and has an elastic force, when a lower side of the supporter 30 is inserted through an open portion of the housing 10, the holders 35 are pressurized by an inner surface of the housing 10 and are folded in a direction in which the bulging parts 33 are close to each other, and when the holders 35 are inserted into the guides 12, both bulging parts 33 are restored to an original shape thereof due to an elastic force.

That is, the supporter 30 is easily coupled to or separated from the housing 10 using the above-described features of the bulging parts 33.

When the moving part 20 moves downward in a state in which the above-described holders 35 are inserted into the guides 12, the holders 35 move downward along the guides 12 and guides the supporter 30 moving downward.

Further, while the moving part 20 is moved upward by the return part 60, the stoppers 13 are moved upward along the guides 12 and guide the supporter 30 moving upward.

Meanwhile, the stamp 40 is for printing a putting line or mark on the surface of the golf ball 70 fixed to the holders 11 and dividedly formed into a putting-line printing stamp 40a for printing a putting line on the surface of the golf ball 70 and a mark printing stamp 40b for printing a mark on the surface of the golf ball 70.

The putting-line printing stamp 40a and the mark printing stamp 40b are selectively coupled to or separated from the supporter 30 using a first detachable part described below.

Each of the putting-line printing stamp 40a and the mark printing stamp 40b includes a printer 41 of which one side has a printing surface 411 and a case 42 mounted on an outer surface of the printer 41 to fix and protect the printer 41.

A fixture (not shown) in a groove or protrusion shape for stably fixing the printer 41 may be formed on the case 42, and the printing surface 411 has a shape which is exposed to the outside of the case 42 and faces the golf ball 70.

The printing surface 411 is formed to have an inner circumferential surface corresponding to an outer circumferential surface of the golf ball 70, and thus the entire printing surface 411 is completely pressed against the golf ball 70.

Although not shown in the drawing, a putting line is formed in a recessed or embossed shape on the printing surface 411 of the putting-line printing stamp 40a, and a mark is formed in a recessed or embossed shape on the printing surface 411 of the mark printing stamp 40b.

The putting line is for informing a golfer of a putting direction and may be formed in an alphabet-T shape.

In the above case, a horizontal portion may be utilized for indicating a position of a putter, and a vertical portion may be utilized for indicating the putting direction.

The shape of the putting line is not limited to the alphabet-T shape and may be one of various shapes which are generally used for a putting line in the field.

The mark is for identifying the golf ball 70 of a user in a public place such as a field, and a shape thereof may be formed in one of various shapes such as a logo, an image, a figure, initials of the user, a signature of the user, etc.

Further, the mark may be formed on the printing surface 411 with one or more selected from the logo, the image, the figure, the initials of the user, and the signature of the user.

That is, the mark may be made to have a shape fitting a user's preference.

When such a mark is printed on the golf ball 70, a selection range of an identification mark is wide, and thus several persons can each select a different mark to be used.

Further, the printing surface 411 may be formed to have the putting line together with the mark, and in this case, the putting line and the mark may be simultaneously printed on the surface of the golf ball 70 using one stamp 40.

The printer 41 itself is filled with a stamping ink or ink and may be formed of a slab or sponge material having absorbency or one of other various rubber materials in a type similar to a sponge.

That is, since a plurality of valleys and protrusions are repeatedly and alternately formed on the surface of the golf ball 70 in general, when the printer 41 is formed of a material having elasticity, the printing surface 411 does not come into contact with the valleys of the golf ball 70 and comes in contact with only the protrusions. In this case, the putting line or mark is printed on only the protrusions of the golf ball 70, and as a result, the putting line or mark printed on the surface of the golf ball 70 is not smoothly made, and identification of the golf ball 70 is not easy in the field.

Accordingly, when the printer 41 is formed of a slab, a sponge material, or one of other various rubber materials in a type similar to a sponge, the printing surface 411 may come into contact with all of the relevant protrusions and valleys of the golf ball 70. Therefore, the putting line or mark may be printed on the surface of the golf ball 70 in a continuous shape, without disconnection, and thus the identification of the golf ball 70 can be easy.

Further, since the inside of the printer 41 is filled with an ink or stamping ink, the printer 41 can be continually used without replacement of the printer 41.

A method of injecting an ink or stamping ink into the printer 41 may use a method of dropping an ink or liquefied stamping ink onto the printing surface 411 and having the ink or liquefied stamping ink permeate the inside of the printing surface 411 or a method of injecting an ink or liquefied stamping ink into an injection hole 421 which is formed in the case 42 and connected to the printer 41.

Further, any color of the ink or stamping ink may be used, but a color having excellent visibility is preferably applied to the golf ball 70 so that a user can easily identify the golf ball 70 in the field.

As described above, the first detachable part may be used for selectively coupling or separating one of the putting-line printing stamp 40a and the mark printing stamp 40b to or from the supporter 30, and the first detachable part includes first slides 31 and first rails 43.

The first slides 31 may be formed on both sides of one of the stamp 40 and the supporter 30, and the first rails 43 may be formed in both sides of the remainder. Hereinafter, an example in which the first slides 31 are formed on the supporter 30 and the first rails 43 are formed in the stamp 40 will be described.

All the entire first slides 31 may be formed in a rectangular bar or trapezoidal shape having a predetermined length and may be symmetrically formed on inner surfaces of lower ends of both of the bulging parts 33 of the supporter 30, and an empty space is formed between the first slide 31 and a lower surface of the supporter 30.

That is, a cross-sectional shape of a combination of the bulging part 33 and the first slide 31 is a roughly “L” shape.

The first slide 31 is formed in a width direction of the bulging part 33 to smoothly slide along the first rail 43.

The first rail 43 is formed in an upper portion of each side surface of the case 42, and a sliding guide groove 431, along which the first slide 31 inserted into a roughly central portion of the case 42 slides, is formed in a longitudinal direction.

That is, since the putting-line printing stamp 40a and the supporter 30 or the mark printing stamp 40b and the supporter 30 may be coupled to or separated from each other using the first rail 43 and the first slide 31 sliding along the first rail 43, the golf ball liner 1 according to the embodiment of the present invention may selectively print the putting line or mark on the surface of the golf ball 70.

Here, the first slide 31 and the first rail 43 may be formed of materials having opposite polarities so that the first slide 31 and the first rail 43 are attached to each other through a magnetic force.

In the above case, since coupling stability between the supporter 30 and the stamps 40a and 40b is secured, the stamp 40 may not move during a process of printing the putting line or mark on the surface of the golf ball 70, and failure of the putting line or mark printed on the surface of the golf ball 70 may be prevented.

Hereinafter, inherent effects of the operation of a golf ball liner according to the embodiment of the present invention and a process of the operation will be described with reference to FIGS. 5 to 9.

First, the golf ball 70 is accommodated through the entrance 10a of the housing 10 and fixed to the holders 11.

Here, the stamp 40 coupled to the supporter 30 may be the putting-line printing stamp 40a.

Then, when a predetermined amount of force is applied to the moving part 20 and the moving part 20 is moved downward as shown in FIG. 6, the supporter 30 and the putting-line printing stamp 40a move downward, and a putting line is printed on the surface of the golf ball 70.

Here, since the stoppers 13 move downward along the guides 12 during a process of moving the moving part 20, the supporter 30, and the putting-line printing stamp 40a downward, the putting-line printing stamp 40a straightly moves downward toward the golf ball 70.

Further, during the process of moving the moving part 20, the supporter 30, and the putting-line printing stamp 40a downward as described above, the return part 60 is in a compressed state between the ceiling surface of the moving part 20 and the upper end of the housing 10.

When the force applied to the moving part 20 is released after the putting line is printed on the surface of the golf ball 70 as described above, the return part 60 restores to have an original shape, and the moving part 20, the supporter 30, and the putting-line printing stamp 40a move upward to return to original positions thereof.

Here, during the process of moving the moving part 20, the supporter 30, and the putting-line printing stamp 40a upward, the moving part 20, the supporter 30, and the putting-line printing stamp 40a are straightly moved upward by the stopper 13 and the guide 12.

Further, the return part 60 is installed between the upper end of the housing 10 and the ceiling surface of the moving part 20 so that the moving part 20 automatically returns to the original position thereof.

Then, when a mark is printed on the surface of the golf ball 70, the supporter 30 is separated from the housing 10 as shown in FIG. 7, the putting-line printing stamp 40a is separated from the supporter 30 in a sliding manner, and the mark printing stamp 40b is coupled to the supporter 30 in a sliding manner.

Then, the golf ball 70 is received through the entrance 10a of the housing 10 and fixed to the holders 11, a predetermined amount of force is applied to the moving part 20 to move the supporter 30 and the putting-line printing stamp 40a downward so that a mark is printed on the surface of the golf ball 70.

As described above, since the putting-line printing stamp 40a or the mark printing stamp 40b is easily coupled to the supporter 30 using the first detachable part and thus the golf ball liner 1 according to the embodiment of the present invention may selectively print the putting line or mark on the surface of the golf ball 70, utilization thereof is broad.

Further, unlike a conventional technique in which a putting line or mark is manually printed on the golf ball 70 using a pencil, because the golf ball liner 1 according to the embodiment of the present invention may rapidly and exactly print a putting line or mark in a stamp 40 manner, golf can be smoothly played without delay.

In addition, when the golf ball liner 1 according to the embodiment of the present invention is not used and stored in a storage place such as a drawer as shown in FIGS. 8 and 9, a predetermined amount of force is applied to the moving part 20 and the moving part 20 is moved downward so that the holder 35 and the stopper 13 are positioned on a horizontal line.

Here, the return part 60 is in a compressed state between the housing 10 and the moving part 20, and the auxiliary return part 50 is in a compressed state between the moving part 20 and the supporter 30.

Subsequently, when the moving part 20 is rotated in one direction, holders 35 are fixedly hooked on the respective stoppers 13, an overall length of the golf ball liner 1 may thus be reduced to about half thereof, and space utilization of the storage place can be improved.

On the other hand, when the golf ball liner 1 is used again, the moving part 20 is rotated in the other direction so that the holders 35 escape from the stoppers 13, the return part 60 and the auxiliary return part 50 are restored to original shapes thereof, and the moving part 20, the supporter 30, and the stamps 40a and 40b return to the original positions thereof.

In the golf ball liner according to the embodiment of the present invention, a putting-line printing stamp or a mark printing stamp can be easily coupled to a supporter using a first detachable part so that a putting line or mark is selectively printed on a surface of a golf ball, and thus utilization thereof is broad.

Further, unlike a conventional technique in which a putting line or mark is manually printed on a golf ball using a ballpoint pen, because the golf ball liner according to the embodiment of the present invention can rapidly and exactly print a putting line or mark in a stamp manner, golf can be smoothly played without delay.

In addition, when the golf ball liner is not used and stored in a storage place such as a drawer, a predetermined amount force is applied to a moving part and the moving part is moved downward so that holders and stoppers are positioned on a horizontal line, the moving part is then rotated and both holders are fixedly hooked on the stoppers, and thus an overall length of the golf ball liner is reduced to about half thereof and space utilization of the storage place can be improved.

As described above, the present invention is described with the embodiments illustrated in the drawing. However, the present invention is not limited thereto, and various modified embodiments or other embodiments within a scope equivalent to the scope of the present invention may be made by those skilled in the art to which the present invention pertains to easily carry out.

What is claimed is:

1. A golf ball liner comprising:
a housing having an inside space in which a golf ball is accommodated;
a moving part mounted on the housing and configured to move toward or away from the golf ball;
a supporter mounted in an inside space of the moving part;
a stamp supported by the supporter and configured to move with the moving part and the supporter to print a putting line or mark on the golf ball; and
a first detachable part formed on each of the stamp and the supporter and configured to couple or separate the stamp to or from the supporter.

2. The golf ball liner of claim 1, wherein the first detachable part has first slides formed on both sides of one of the stamp and the supporter and first rails formed in both sides of the remainder so that the stamp is separated from or coupled to the supporter in a sliding manner.

3. The golf ball liner of claim 1, further comprising a second detachable part formed on each of the moving part and the supporter and configured to couple or separate the moving part to or from the supporter,
wherein the second detachable part has second slides formed on both sides of one of the moving part and the supporter and second rails formed in both sides of the remainder so that the stamp is separated from or coupled to the supporter in a sliding manner

4. The golf ball liner of claim 3, further comprising a return part installed between the moving part and the housing and configured to return the moving part moved in a direction of the golf ball to an original position thereof using an elastic force.

5. The golf ball liner of claim 3, further comprising:
holders formed on both sides of the supporter and spaced a predetermined gap from the second rail or the second slide;
guides formed on both sides of the housing and configured to guide the holders to stoppers; and
the stoppers, each connected to an end of the guide in a perpendicular direction, wherein the holders are fixedly hooked on the stoppers when the moving part is rotated.
